(19) United States
(12) Patent Application Publication
(10) Pub. No.: US 2002/0184009 A1
(43) Pub. Date: Dec. 5, 2002

(54) Method and apparatus for improved voicing determination in speech signals containing high levels of jitter

(76) Inventor: Ari P. Heikkinen, Tampere (FI)

Correspondence Address: PERMAN & GREEN, 425 POST ROAD, FAIRFIELD, CT, 06824, US

(21) Appl. No.: 09/871,086

(22) Filed: May 31, 2001

(51) Int. Cl. G10L 19/04

(52) U.S. Cl. 704/219; 704/501

(57) ABSTRACT

In an embodiment of the invention, a method is presented to minimize the effect of pitch jitter in voicing determination of sinusoidal speech coders during voiced speech. In the method, the pitch of the input signal is normalized to a fixed value prior voicing determination in the analysis frame. After that, conventional voicing determination approaches can be used for the normalized signal. Based on experiments done, the method has been shown to improve the performance of sinusoidal speech coders during jittery voiced speech by increasing the accuracy of voicing classification decisions of speech signals.

### FIELD OF THE INVENTION

The present invention relates generally to speech signals and, more specifically, to an method of processing said signals for improving the accuracy of voicing decisions in speech compression systems such as speech coders.

### BACKGROUND OF THE INVENTION

In the field of speech analysis a speech signal can be roughly divided into classifications that are composed of voiced speech, unvoiced speech, and silence. It is well known in the field of linguistics that speech, when uttered by humans is composed of phonemes which produce sound by a combination of factors that include the vocal cords, the vocal tract, movement and filtering of the mouth, lips and teeth etc. Voiced speech are known as those sounds that are produced when the vocal cords vibrate daring the pronunciation of a phoneme. Phonemes are the smallest phonetic unit in a language that are capable of conveying a distinction in meaning. In contrast, unvoiced speech do not entail the use of the vocal cords, examples include the sounds made when pronouncing the letters /s/ and /f/. Voiced speech tends to be louder in uttering vowels such as a/, e/, /i /, /u/, /o/ where, unvoiced speech tends to be more abrupt such as in the stop consonants like /p/, /k/, and /t/, for example. Usually, however, speech signal also contains segments which can be classified as a mixture of voiced and unvoiced speech. Examples of speech in this category include voiced fricatives, and breathy and creaky voices.

In the transmission of speech signals, an analog voice signal is typically converted into an electronic representation of the signal which can then be transmitted and re-converted back at the receiver into the original signal. It should be noted that he term speech signal is used herein to refer to any type of signal derived from the utterances from a speaker e.g. digitized signals such as residual signals etc. Such a transmission method is widely used in the fields where voice transmission is performed over the air such as in radio telecommunication systems. However transmitting the full speech spectrum requires significant bandwidth in an environment where spectral resources are scarce therefore the use of compression techniques are typically employed through the use of speech encoding and decoding. Speech coding algorithms also have a wide variety of applications in wireless communication, multimedia and storage systems. The development of the coding algorithms is driven by the need to save transmission and storage capacity while maintaining the quality of the synthesized signal at a high level. These requirements are somewhat contradictory, and thus a compromise between capacity and quality must be made.

Speech coding algorithms can be categorized in different ways depending on the criterion used. The most common classification of speech coding systems divides them into two main categories consisting of waveform coders and parametric coders. The waveform coders, as the name implies, try to preserve the waveform being coded without paying much attention to the characteristics of the speech signal. Parametric coders, on the other hand, use a priori information about the speech signal via different models and try to preserve the perceptually most important characteristics of speech rather than to code the actual waveform. Currently, parametric speech coders are widely considered to be a promising approach for achieving high quality at bit rates of 4 kbps and below, while this is typically not true for waveform speech coders. In a typical parametric speech coder, the input speech signal is processed in frames. Usually the frame length is 10-30 ms, and a look-ahead segment of 5-15 ms of the subsequent frame is also available. In every frame, a parametric representation of the speech signal is determined by an encoder. The parameters are quantized, and transmitted through a communication channel or stored in a storage medium in digital form. At the receiving end, a decoder constructs a synthesized speech signal representative of the original signal based on the received parameters. Most parametric coders are typically based on a sinusoidal model which assumes that a frame of speech is represented by a set of frequencies, amplitudes and phases. These parameters are derived from the Fourier transform given by,

$$S ( {ⅇ}^{jω} ) = {\sum }_{n = - ∞}^{∞} s ( n ) {ⅇ}^{- jω n} , \qquad ( 1 )$$

The corresponding inverse Fourier transform is given by,

$$s ( n ) = \frac{1}{2 π} {\int }_{- π}^{π} S ( {ⅇ}^{jω} ) {ⅇ}^{- jω n} ⅆ ω , \qquad ( 2 )$$

where s(n) is the input sequence and S(e^{∫ω}) is the corresponding Fourier transform. For a frame wise analysis the input speech signal is multiplied by a finite length, lowpass window function w(n). This multiplication results into a new sequence \tilde{s}(n) given by,

\tilde{s}(n)=s(n)w(n),tm (3)

The multiplication of the input sequence s(n) and window function w(n) in the time domain results in periodic convolution in the frequency domain. This is defined by,

$$\tilde{S} ( {ⅇ}^{jψ} ) = \frac{1}{2 π} {\int }_{- π}^{π} S ( {ⅇ}^{jψ} ) W ( {ⅇ}^{- j ( ω - ψ )} ) ⅆ ψ , \qquad ( 4 )$$

where W(e^{∫ω}) is the Fourier transform of the window function w(n).

FIG. 1 illustrates an exemplary amplitude spectrum |W(e^{∫ω}) | versus frequency (rad) of the Hamming window of equation (4). In low bit rate sinusoidal coders, a speech frame is typically modeled using harmonic frequencies resulting in,

$$\tilde{s} ( n ) = {\sum }_{l = 1}^{L} {A}_{l} cos ( n l {ω}_{0} + {θ}_{l} ) , \qquad ( 5 )$$

where A₁ and θ₁ represent the amplitude and phase of each sine-wave component associated with the harmonic frequency, ω₀, is the fundamental frequency and can be interpreted as the speaker's pitch during voiced speech, and L being the number of harmonic frequencies. To reduce the bit rate further and also to cope with speech signals having different voicing characteristics, the speech signal in a frame is usually divided into glottal excitation and vocal tract components to allow an efficient representation For the sine-wave phase information. For the excitation signal, a linear phase model is usually applied for the voiced sine-wave components. On the other hand, random phase is typically applied for the unvoiced frequencies. The resulting sinusoidal model for the excitation signal can thus be described for example by,

$$\tilde{s} ( n ) = {\sum }_{l = 1}^{L} {A}_{l} cos [ ( n - {n}_{0} ) / {ω}_{0} + {φ}_{l} ] \qquad ( 6 )$$

where A₁ now represents the amplitude for each sine-wave component in the excitation signal and n₀ is the linear phase term representing the occurrence of a pitch pulse. φ₁ is the random phase component which is set to zero for the unvoiced frequency components. The vocal tract component in a speech signal is often assumed to be minimum phase and can be modeled e.g. by a linear prediction (LP) filter.

To determine the voiced and unvoiced frequencies there have been a number of voicing determination methods which typically rely on the periodicity of the frequency or time domain speech signal. One commonly used method is presented in “Multiband Excitation Vocoder” by Griffin and Lim, IEEE Transactions on Acoustics, Speech, and Signal Processing, Vol. 36, No. 8 August 1988. The method relies on the use of normalized autocorrelation strength for each harmonic frequency band to determine whether the corresponding harmonic is voiced or unvoiced. It is well known by those in the art that, in the frequency domain, the voiced speech waveform is much more periodic as compared to that of unvoiced speech.

As previously mentioned, sinusoidal speech coding has shown to be a promising approach for achieving high speech quality at low bit rates. However, one widely accepted deficiency of sinusoidal coders is their inability to mimic abrupt changes in the signal during nonstationary speech, such as voiced onsets and offsets and plosives. Also, the correct determination of the sinusoidal parameters is essential to achieve high quality as in most parametric coders the errors due to false parameter values cannot be fixed with decreasing quantization error. One relatively sensitive part of sinusoidal coders is voicing determination, whose performance typically degrades for speech segments having relatively large variations in the pitch contour, for example. The pitch variation and the corresponding speech segments are referred to herein as pitch jitter, jittery speech, or simply jitter. Although some amount of jitter occurs naturally in human speech production and varies with the individual speaker, excessive amounts of jitter can be problematic for sinusoidal coders. It has been found that the effect of jitter can be notable in frames as short as 10 ms and below. Naturally, the amount of jitter typically increases as a function of the length of the speech segment to be analyzed.

FIG. 2 illustrates an exemplary voiced LP residual signal and its corresponding amplitude spectrum illustrating its strongly periodic character. The high periodicity accentuates a pattern where the peaks of the amplitudes bear out a discernable pitch period that is indicative of voiced speech which can be easily detected by analysis algorithms.

FIG. 3 illustrates an exemplary unvoiced LP residual signal and its corresponding amplitude spectrum. The amplitude spectrum of the unvoiced signal is largely random and resembles that of random noise.

Further complicating the ability to accurately determine the voice classes is when the speech signal contains a combination of voiced and unvoiced speech. This is the most realistic situation since speech uttered by users often contain a mixture of voiced and unvoiced components.

FIG. 4 shows an exemplary mixed LP residual signal containing voiced and unvoiced speech and its corresponding amplitude spectrum. The spectrum contains bands that are clearly periodic followed by a band having a relatively random pattern that is indicative of unvoiced speech followed by a more periodic pattern that is indicative of voiced speech. In the example shown there are two voiced bands and one unvoiced band.

The introduction of jitter to voiced speech tends to distort the periodicity of the spectrum which may further lead to the model to inaccurately determine and thus classify a segment of the spectrum as unvoiced, The problem is exacerbated during intervals of rising or falling pitch, where the speech signal will appear to be less periodic even though it may still be strongly voiced. The consequence of having significant number of misclassified segments is noisy output speech quality.

In view of the foregoing, an improved method is needed that enables speech coders to more accurately determine the voicing information of a speech signal having excessive levels of pitch jitter.

### SUMMARY OF THE INVENTION

Briefly described and in accordance with an embodiment and related features of the invention, in a method aspect of the invention there is provided a method of encoding speech comprising the steps of:

formulating a speech signal from utterances spoken by a speaker;

determining an estimate of periodicity from the formulated signal;

modifying the formulated signal using the periodicity estimate such that the periodicity is improved; and

encoding the modified signal in a speech encoder.

In an apparatus aspect of the invention there is provided an apparatus for generating a modified signal suitable for use with an speech encoder/decoder comprising:

means for formulating a speech signal from utterances spoken by a speaker;

means for determining an estimate of periodicity from the formulated signal;

means for modifying the formulated signal using the periodicity estimate such that the periodicity is improved; and

means for encoding the modified signal in the speech encoder/decoder.

In a further apparatus aspect of the invention there is provided a mobile device comprising:

a speech coder;

means for formulating a speech signal from utterances spoken by a speaker;

means for determining an estimate of periodicity from the formulated signal;

means for modifying the formulated signal using the periodicity estimate such that the periodicity is improved; and

means for encoding the modified signal in the speech coder.

In a still further apparatus aspect there is provided a network element comprising:

means for formulating a speech signal from utterances spoken by a speaker;

means for determining an estimate of periodicity from the formulated signal;

means for modifying the formulated signal using the periodicity estimate such that the periodicity is improved; and

means for encoding and decoding speech signals using the modified signal.

### BRIEF DESCRIPTION OF THE DRAWINGS

The invention, together with further objectives and advantages thereof, may best be understood by reference to the following description taken in conjunction with the accompanying drawings in which:

FIG. 1 illustrates an exemplary amplitude spectrum of a Hamming window;

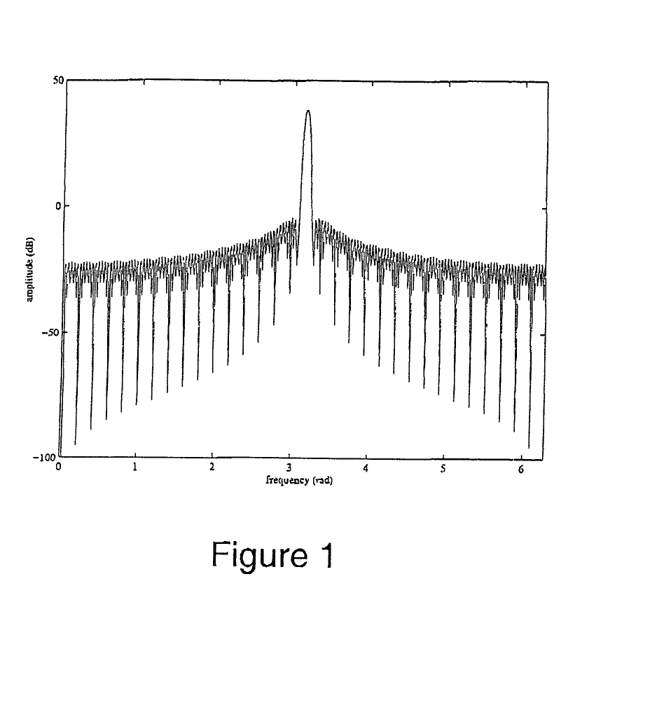

FIG. 2 illustrates an exemplary voiced LP residual signal and its corresponding amplitude spectrum;

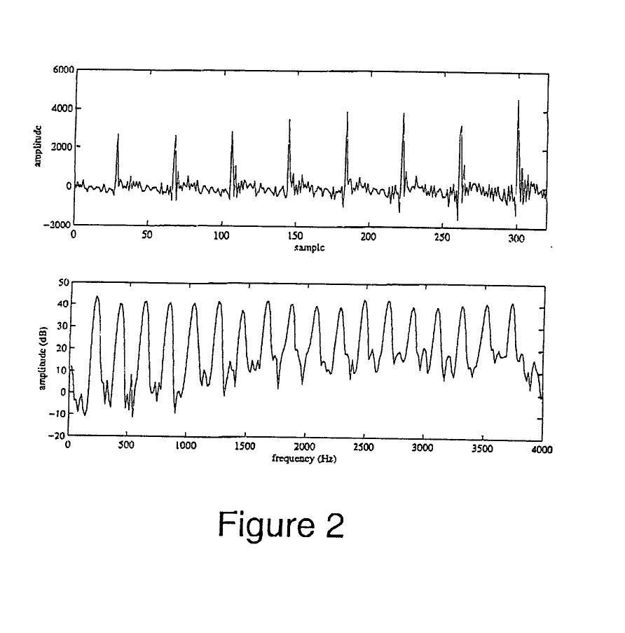

FIG. 3 illustrates an exemplary unvoiced LP residual signal and its corresponding amplitude spectrum;

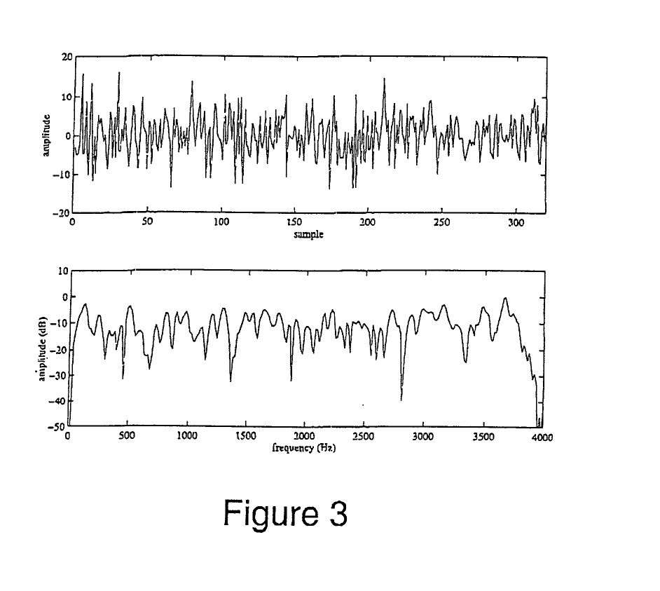

FIG. 4 shows an exemplary mixed LP residual signal containing voiced and unvoiced speech and its corresponding amplitude spectrum;

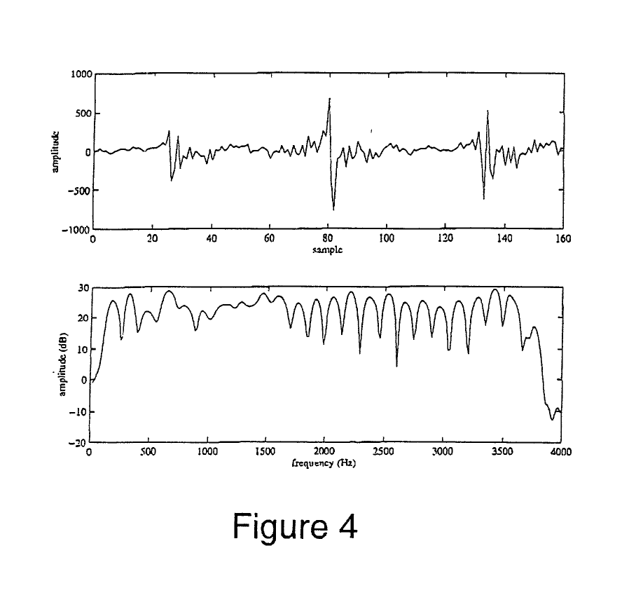

FIG. 5 illustrates an exemplary LP residual segment containing jitter and its corresponding amplitude spectrum;

FIG. 6a shows an exemplary normalized LP residual signal operating in accordance with an embodiment of the invention;

FIG. 6b illustrates a more detailed view of the TD-PSOLA pitch scaling method used in accordance with the embodiment of the invention; and

FIG. 7 is a block diagram of the process steps operating in accordance with the embodiment of the invention.

### DETAILED DESCRIPTION OF THE INVENTION

One commonly used speech analysis method is Linear Predictive (LP) Coding. In LP coding analysis it is assumed that the current speech sample can approximately be predicted by a linear combination of the past samples and corresponding transfer function is often called an LP synthesis filter. The inverse of the synthesis filter is called analysis filter and the prediction error signal which is obtained by subtracting the predicted signal from the original signal, is called residual signal. In the ideal predictor the spectrum of the residual signal is flat.

To address the aforementioned problems relating to voicing determination during jittery voiced speech, the present invention discloses a method where pitch jitter is effectively removed from the analyzed signal by normalizing its pitch period to a fixed length. After normalization, conventional frequency or time domain approaches for voicing determination can be employed to the pitch normalized signal.

As mentioned, voiced speech typically show characteristics of being strongly periodic in both time and frequency domains where unvoiced speech tends to be much less so. Most of the prior-art speech coders typically derive voicing information from different periodicity indicators such as normalized autocorrelation strength. The introduction of jitter tends to distort the periodicity thereby complicating the accurate determination of the voicing information.

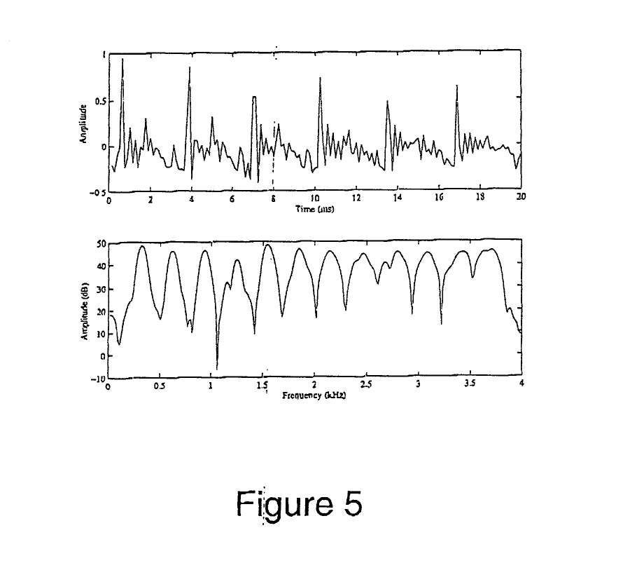

FIG. 5 illustrates an exemplary LP residual segment containing jitter and its corresponding amplitude spectrum that shows a distortion in its periodicity. This is because the energy is spread at the higher harmonics by becoming more smeared.

In an embodiment of the invention, the pitch period of the speech signal is normalized to a certain length inside the analysis frame. Instead of determining the voicing information from the original signal, in the invention it is determined from the normalized speech or residua) signal from which the pitch jitter is effectively removed. According to performed experiments, it has been found that better performance can be achieved if the pitch modification is done for the upsampled signal rather than for the original signal. After pitch modification, the modified upsampled signal is downsampled to the original sampling rate (8 kHz in our examples) and the voicing analysis is then done for the downsampled signal. For upsampling and downsampling, sinc interpolation with a fraction of six can be used. As there exists several methods for modifying the pitch structure of a speech signal, the proposed method of this invention is described in the following description.

Before pitch normalization the different pitch cycles inside the analysis frame are first identified from the upsampled signal. The identification of pitch cycles in the analysis frame is based on finding the events of pitch onsets, or similarly pitch pulses, which correspond to the instants of glottal closing in the LP residual signal. A pitch cycle is in this context is defined as a region between two successive pitch pulses. The LP residual signal is used for pitch pulse identification since it is typically characterized by clearly outstanding pitch pulses and low power regions between them. In the approach taken in the embodiment, a pitch pulse is found at location n if the following condition is true:

|r(n−i)|≦|r(n)|, i =−┌( τ/2)┐, . . . ,┌(τ/2)┐, (7)

where τ is the upsampled pitch period estimate for the analysis frame and r is the LP residual signal. To find every pitch pulse position within the analysis frame, index n runs from the beginning of the analysis frame to the end of it. It should be noted that a look-ahead of ┌τ/2┐ samples is needed beyond the analysis frame to be able to reliably identify the possible pitch pulses at the end of the analysis frame. The found pitch pulses in the analysis frame are denoted as tᵤ (u). Once all pitch pulses are found, local pitch estimates are defined by the distances between successive pitch pulses dᵤ (u)=t(u+1)−tᵤ (u). Next, the length of the normalized pitch cycles is defined by:

$${τ}_{norm} = \frac{1}{K - 1} {\sum }_{u = 1}^{K - 1} {d}_{a} ( u ) , \qquad ( 8 )$$

where K is the number of the pitch pulses found. For pitch normalization, a new set of pulse positions tₓ (u) is defined by:

rₓ (u +1)=tₓ (u)+τₙₒᵣₘ, u +1, . . . ,K (9)

where tₓ (1)=tᵤ (1).

To normalize the pitch cycle lengths in the analysis frame, a pitch scaling algorithm is needed. An object for high quality pitch scaling algorithm is to alter the fundamental frequency of speech without affecting the time-varying spectral envelope. To achieve this property, the amplitudes of the pitch-modified harmonics are sampled from the vocal tract amplitude response. Thus, an estimation of the vocal system is needed at frequencies which are not necessarily located at pitch harmonic frequencies in the original signal. Therefore, most pitch scaling algorithms explicitly decompose the speech signal to excitation and vocal tract components.

In the embodiment, the approach chosen for pitch scaling is time domain pitch-synchronous overlap-add (ID-PSOLA). In general PSOLA, the source-filter decomposition and the modification are carried out in a single operation and thus it can be done either for the LP residual signal or alternatively directly for the speech signal. In TD-PSOLA, the short-time analysis signal x(u, n) associated to the analysis time instant tᵤ (u) is defined as a product of the signal waveform and the analysis window h_{H} (n) centered at tᵤ (u)

x (u, n)=hᵤ (tᵤ (u)−n)x(n) (10)

where the length of the analysis widow is at least two times the local pitch period. The synthesis operation in TD-PSOLA to achieve the pitch scaled signal is defined as:

$$y ( n ) = {\sum }_{u} γ ( u ) x ( u , t , ( u ) - n ) \qquad ( 11 )$$

where y (u) is a time varying normalization factor which compensates for the energy modifications.

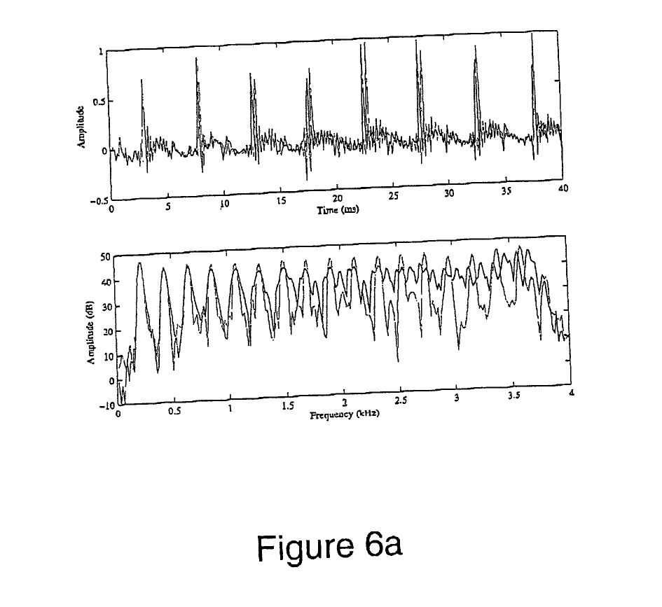

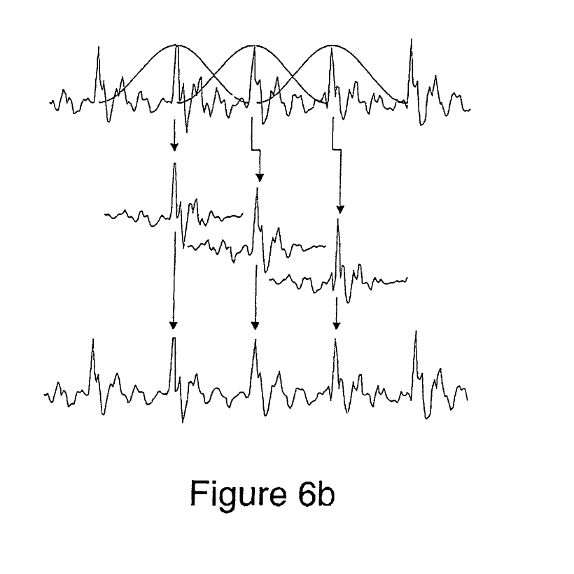

FIG. 6a shows an exemplary normalization process using TD-PSOLA illustrating where the time domain signals and their amplitude spectra are presented for the original LP residual and its normalized version, respectively. In the figure the lighter dotted line signal is the original speech signal and the dark solid line is the normalized signal. As can be seen, the normalization notably increases the periodicity of the original signal both in time domain and the frequency domain, even if the time domain signal is modified very slightly. Therefore, a more reliable voicing estimate can be achieved using either time or frequency domain approaches for the normalized signal.

FIG. 6b illustrates a more detailed view of the TD-PSOLA pitch scaling method used in accordance with the embodiment of the invention. The top signal is the LP residual signal together with the analysis windows (curved segments). The windowing results in the exemplary three extracted pitch cycles which are overlapping, as shown in the middle of the figure. The bottom signal is the pitch modified signal exhibiting improved periodic characteristics.

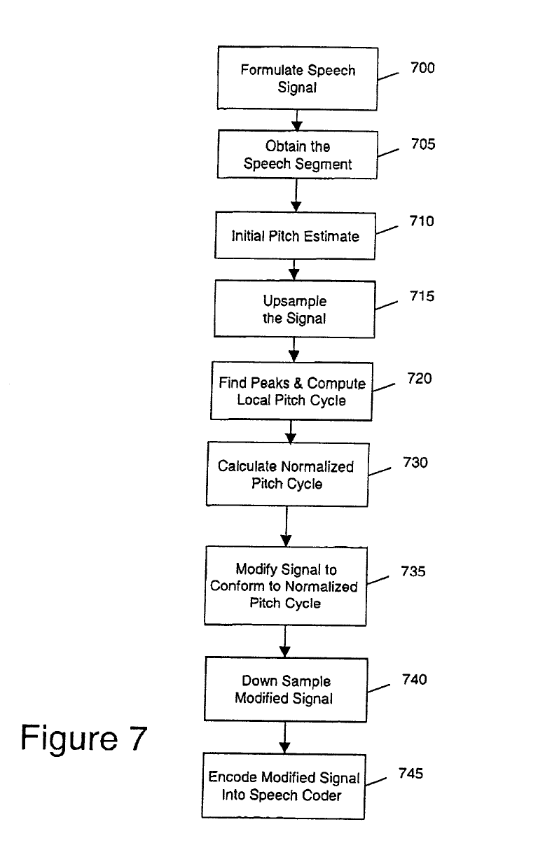

FIG. 7 is a block diagram of the process steps of the method operating in accordance with the embodiment of the invention. In step 700, a speech signal is formulated from an analog speech signal uttered by a speaker. By way of example, the formulated signal can be any type of digitized signal such as an LP residual signal produced by a Linear Predictive Coding algorithm. In an exemplary application, the LP residual signal can be generated by the speech coder in a mobile phone from the utterances spoken by a user, for example. In step 705, a suitable size working segment is extracted from the signal to enable frame-wise operation in the encoder. In step 710, an initial pitch estimate is made from the speech segment. In step 715, the signal is upsampled in order to obtain a representative digital signal that more closely matches the original signal. Furthermore, experimental data has tended to show that the pitch cycle identification and modification has generally performed better in the upsampled domain. In step 720, the periodicity of the peaks are measured which is indicative of the “pitch”, and where the pitch corresponds to the distance between the distinct peaks in the LP residual. The peaks are referred as “pitch pulses” and the LP residual segment corresponding to the length of pitch is referred as a “pitch cycle” whereby a local pitch cycle estimate is computed.

In step 730, a normalized pitch cycle is estimated by calculating the length of the normalized pitch cycles from the segments. In step 735, the signal is modified to conform to a fixed normalized pitch cycle by e.g. shifting the discrete values or by using a pitch scaling algorithm such that the periodicity is improved. In step 740, the modified signal is downsampled prior to being encoded in the speech coder, as shown in step 745.

The present invention contemplates a technique for obtaining improved speech quality output from speech coders of speech signals containing high levels of jitter by suitably modifying the original speech signal prior input into the speech coder. As a consequence, the speech coder is able to more accurate make voicing decisions based on the modified signal i.e. modified signal effectively having the jitter removed enables the speech coder to more successfully discriminate between classes of voicing information.

Although the examples disclosed in the invention are based on pitch normalization of the linear prediction (LP) residual signal, the proposed method can also be applied directly to speech signal itself. This can be done for example just by replacing the LP residual signal used in the given equations by the original speech signal. Furthermore, it is possible apply the invention to the frequency domain by measuring periodicity by estimating the distance between the amplitude peaks in the frequency spectrum of the segments to calculate a normalized pitch cycle, for example. Although the invention has been described in some respects with reference to a specified embodiment thereof, variations and modifications will become apparent to those skilled in the art. It is therefore the intention that the following claims not be given a restrictive interpretation but should be viewed to encompass variations and modifications that are derived from the inventive subject matter disclosed.

1. A method of encoding speech comprising the steps of:
formulating a speech signal from utterances spoken by a speaker;
determining an estimate of periodicity from the formulated signal;
modifying the formulated signal using the periodicity estimate such that the periodicity is improved; and
encoding the modified signal in a speech encoder.

2. A method according to claim 1 wherein the formulated speech signal is a digitized signal such as a residual signal produced from a coding algorithm such as Linear Predictive Coding (LPC) or the actual speech signal itself.

3. A method according to claim 1 wherein the determining an estimate of periodicity step comprises obtaining a normalized pitch cycle by autocorrelation.

4. A method according to claim 3 wherein the modifying step includes normalizing the pitch by shifting the time domain discrete values of the residual signal to conform to the normalized pitch cycle.

5. A method according to claim 4 wherein the modifying step further comprises the speech signal being upsampled by interpolation such that suitable discrete values of the upsampled signal are shifted to conform to the average pitch cycle.

6. A method according to claim 1 wherein a pitch scaling algorithm such as Time Domain Pitch Synchronous Overlap-Add (TD-PSOLA) is used to normalize the pitch cycle lengths in an analysis frame.

7. A method according to claim 5 wherein the modified signal is down sampled prior to encoding in the speech coder.

8. An apparatus for generating a modified signal suitable for use with an speech encoder/decoder comprising:
means for formulating a speech signal from utterances spoken by a speaker;
means for determining an estimate of periodicity from the formulated signal;
means for modifying the formulated signal using the periodicity estimate such that the periodicity is improved; and
means for encoding the modified signal in the speech encoder/decoder.

9. An apparatus according to claim 8 wherein the formulating means includes software operating with a signal processor that is capable of generating a residual signal from a speech signal.

10. An apparatus according to claim 8 wherein the apparatus includes a memory comprising a software operating with a signal processor for providing means for transforming, estimating, and modifying the speech signal.

11. An apparatus according to claim 8 wherein the apparatus is integrated into a mobile device.

12. A mobile device comprising:
a speech coder;
means for formulating a speech signal from utterances spoken by a speaker;
means for determining an estimate of periodicity from the formulated signal;
means for modifying the formulated signal using the periodicity estimate such that the periodicity is improved; and
means for encoding the modified signal in the speech coder.

13. A mobile device according to claim 12 wherein the formulating means includes software operating with a signal processor that is capable of generating a residual signal from a speech signal.

14. A mobile device according to claim 12 wherein the mobile device includes a memory comprising a software operating with a signal processor for providing means for transforming, estimating, and modifying the speech signal.

15. A network element comprising:
means for formulating a speech signal from utterances spoken by a speaker;
means for determining an estimate of periodicity from the formulated signal;
means for modifying the formulated signal using the periodicity estimate such that the periodicity is improved; and
means for encoding and decoding speech signals using the modified signal.

16. A network element according to claim 15 integrated into a radio base station functioning within a wireless telecommunication network.

17. A network element according to claim 15 wherein the formulating means includes software operating with a signal processor that is capable of generating a residual signal from a speech signal.

18. A network element according to claim 15 wherein the mobile device includes a memory comprising a software operating with a signal processor for providing means for transforming, estimating, and modifying the speech signal.
